(19) United States
(12) Patent Application Publication
(10) Pub. No.: US 2012/0282005 A1
(43) Pub. Date: Nov. 8, 2012

(54) Method for Controlling a Control Variable for a Processing Machine

(75) Inventors: Stephan Schultze, Lohr-Wombach (DE); Holger Schnabel, Veitshoechheim (DE)

(73) Assignee: Robert Bosch GmbH, Stuttgart (DE)

(21) Appl. No.: 13/508,165

(22) PCT Filed: Sep. 16, 2010
(86) PCT No.: PCT/EP2010/005677

§ 371 Date: Jul. 23, 2012

(30) Foreign Application Priority Data
Nov. 7, 2009 (DE) 10 2009 052 330.8

(51) Int. Cl. B41J 11/42

(52) U.S. Cl. 400/582

(57) ABSTRACT

A method is disclosed for controlling a control variable for a processing machine, which has driven rollers for transporting and/or for processing a material web, of which rollers at least one is not part of a clamping point. A first control element is pilot-operated based on a second control member according to a control value in order to adjust the at least one driven roller that is not part of a clamping point.

The present invention relates to a method for controlling a control variable for a processing machine, and to a computing unit for carrying out the method.

Although reference is made mainly to printing presses in the following text, the invention is not restricted thereto, but rather is directed to all types of processing machines, in which a material web is processed. However, the invention can be used, in particular, in printing presses, such as newspaper presses, jobbing presses, gravure presses, inline flexographic presses, packaging presses or security presses, and in processing machines, such as bag machines, envelope machines or packaging machines. The material web can be formed from paper, cloth, cardboard, plastic, metal, rubber, in film form, etc.

### PRIOR ART

In processing machines, in particular printing presses, a material web is moved along driven and non-driven rolls. The material web is processed at the same time by means of usually driven processing devices, for example printed, punched, cut, folded, etc. In a processing machine, one or more processing registers (for example, longitudinal register, lateral register) and/or the web tension are/is usually controlled in the prior art.

A driven roll can belong to a clamping point which clamps the material web positively or non-positively and can therefore introduce a web tension into the material web. In a printing press, a clamping point is formed, for example, by a printing unit, in which a non-positive unit exists between the driven impression cylinder, the impression roller and the material web.

The material web can be divided into web tension sections, a web tension section being delimited by two clamping points. Further driven and/or non-driven rolls can be arranged within a web tension section. The entire material web is often divided into a plurality of web tension sections, sometimes also with different web tension setpoint values. A web tension controller is usually used in order to maintain the setpoint values.

It is customary in the prior art to set the register of a processing unit and/or the web tension of a web tension section by corresponding actuation of actuators, such as impression cylinders or their drives, transport rolls or their drives, compensators and the like. On account of the coupling of the individual actuators among one another via the material web, settings of this type are propagated as disruptions and have to be corrected by the associated controllers at following processing units and/or web tension sections. Options are described in the prior art to decouple settings of this type, that is to say to leave the register of other processing units and/or the web tension of other web tension sections uninfluenced in the case of an adjustment.

DE 103 35 885 A1 discloses a combined register and web tension control operation. In order to decouple the register from web tension setting operations, an upstream strategy for the web tension control is proposed.

DE 10 2007 017 096 A1 describes pilot-controlling all following clamping points in the case of downstream control by means of (dynamic) downstream pilot control, in such a way that said clamping points compensate directly for the effects of the leading clamping point. As a consequence, it is ensured that all the following register controllers do not have to compensate for the disruptions of the coupling as a result of the material web.

DE 10 2008 056 132 which is not a prior publication proposes decoupling for an upstream control operation, (dynamic) downstream pilot control by means of PT1 element is also carried out in addition to (constant) upstream pilot control.

However, the previous decoupling methods do not allow equally satisfactory results to be expected for all structural conditions. In particular, processing machines with driven rolls which do not form a clamping point have not yet been taken into consideration sufficiently.

It is therefore desirable to specify an improved control method for processing machines with driven rolls which do not form a clamping point.

### DISCLOSURE OF THE INVENTION

According to the invention, a method for controlling a control variable for a processing machine having the features of patent claim 1 and a computing unit for carrying out said method are proposed. Advantageous refinements are the subject matter of the subclaims and of the following description.

### ADVANTAGES OF THE INVENTION

In addition to the abovementioned processing and transport rolls, other typically high-mass rolls with dedicated drives also exist in processing machines. For example, it is known from DE 10 2006 047 846 A1 to also drive cooling and/or guide rolls, in order to improve the maintenance of register. Since said other rolls neither form clamping points nor carry out in-register processing of the material, they are not taken into consideration in known decoupling strategies. However, it has been recognized that said rolls nevertheless influence the decoupling negatively. It has been shown that an incorporation of said rolls into the decoupling strategy, for example by pilot control as a function of the crucial actuating value, leads to a significant improvement in the decoupling. The integration expediently takes place into the known strategies (upstream or downstream optionally in combination with standard color or precursor color control). The pilot control expediently takes place during the control of a processing register and/or a web tension. The driven roll is pilot-controlled as first actuator as a function of the adjustment (crucial actuating value) of a second actuator.

In one refinement, the pilot control takes place during the acceleration phase, for example the running up of the machine. Friction occurs between the processing roll and the driven roll, typically as a result of further non-driven rolls, such as guide rolls. Said friction leads to a steady-state control discrepancy. Furthermore, the non-driven rolls have a moment of inertia which has to be overcome in the event of speed changes. This leads to a dynamic control discrepancy. In order for it to be possible for said influences to be compensated for by the controller not only after the occurrence of the control discrepancy, the at least one driven roll can be pilot-controlled correspondingly in the event of a speed change.

In particular in the event of a speed change, the pilot control can take place in a model-based and/or adaptive manner. Model-based means that the corresponding pilot control variable is calculated from physical variables, such as material web speed, format, modulus of elasticity, inertia, friction, acceleration, etc. Adaptive means that the pilot control variable is optimized after every acceleration phase. In particular, a learning algorithm may be suitable for this purpose, which learning algorithm observes the pilot control variable (for example, the actuating variable for the drive of the roll) during a speed change using a control discrepancy which still occurs, optimizes said pilot control variable and thus adapts it automatically to changing production conditions (for example, change in the ambient temperature, moisture, dryer temperature, etc.).

A sliding slippage and/or expansion slippage is expediently taken into consideration during the pilot control. Since the rolls are not a constituent part of a clamping point and they are wrapped around only by the material web, an air film can be formed between the roll and the material web at relatively high speeds and can reduce the static friction zone as a result. This can lead to pilot control of the roll no longer acting completely on the material web. Complete decoupling of the adjusting movement therefore no longer occurs, since complete force transmission from the cooling roll to the material web no longer takes place. The sliding slippage which occurs is advantageously taken into consideration correspondingly in the pilot control, with the result that, for example, the pilot control is increased as the force transmission decreases.

In one refinement, the at least one driven roll is controlled and at least one third actuator is pilot-controlled as a function of the actuating value for the first actuator. If the driven roll itself is integrated into a control operation, dedicated actuating values are generated for this roll, which actuating values, processed correspondingly by a decoupling network, are in turn used for the pilot control of other actuators, in order to improve the decoupling.

A computing unit according to the invention, for example a control unit of a printing press, is set up, in particular in terms of programming technology, to carry out a method according to the invention.

The implementation of the invention in the form of software is also advantageous, since this makes particularly low costs possible, in particular if a computing unit which implements it is also used for further tasks and is therefore present in any case. Suitable data storage media for providing the computer program are, in particular, diskettes, hard drives, flash memories, EEPROMs, CD-ROMs, DVDs and others. A download of a program via computer networks (Internet, Intranet, etc.) is also possible.

Further advantages and refinements of the invention result from the description and the appended drawing.

It goes without saying that the features which are mentioned above and are still to be explained in the following text can be used not only in the respectively specified combination, but rather also in other combinations or on their own, without departing from the scope of the present invention.

The invention is shown diagrammatically in the drawing using an exemplary embodiment and will be described in detail in the following text with reference to the drawing.

### DESCRIPTION OF THE FIGURES

FIG. 1 shows a diagrammatic illustration of a processing machine which is configured as a printing press and has independently driven cooling rolls.

FIG. 2 shows a diagrammatic illustration of one example of a control strategy according to the invention for a printing press according to FIG. 1.

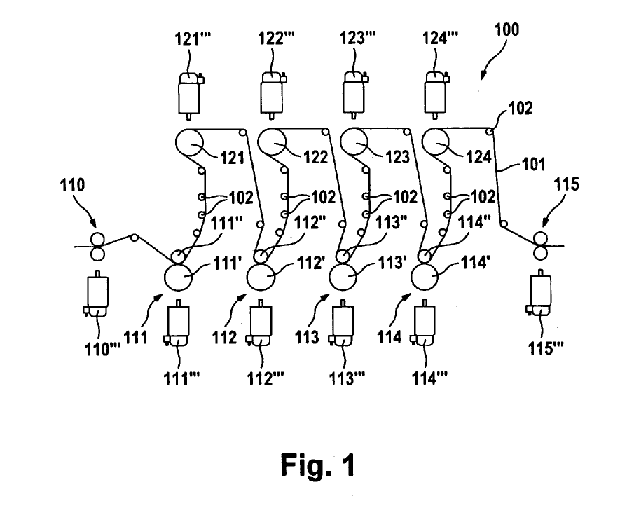

FIG. 1 diagrammatically shows a processing machine which is configured as a printing press, as can form the basis of the present invention and is designated as a whole with 100. A printing material, for example paper 101, is fed to the machine via an infeed unit 110. The paper 101 is guided through processing devices which are configured as printing units 111, 112, 113, 114, and are printed and are output again by an outfeed unit 115. The infeed, outfeed and printing units 110 to 115 are arranged such that they can be positioned, in particular can be corrected with respect to cylinder and/or angle. The printing units 111 to 114 lie in a region of controlled web tension between the infeed unit 110 and the outfeed unit 115.

The printing units 111 to 114 in each case have an impression cylinder 111′ to 114′, against which in each case one impression roller 111″ to 114″ is set with great pressure. The impression cylinders 111′ to 114′ are driven individually and independently. The associated drives 111″ to 114″ are diagrammatically shown. The impression rollers 111″ to 114″ are configured so as to be freely rotatable. The infeed and outfeed units 110 and 115 in each case have two cylinders which run in opposite directions and guide the paper 101. In each case one transport roll of the infeed and outfeed unit is also driven individually by a drive 110″′ and 115″′, respectively. The infeed and outfeed units 110, 115 and the printing units 111 to 114 in each case form a clamping point.

In the web sections between the individual printing units 111 to 114, the paper 101 is guided over rollers which are denoted by 102 and are not described in greater detail. For reasons of clarity, not all rollers are provided with designations 102. They can be, in particular, deflection rollers, drying devices, trimming devices, etc.

In each case one dryer which dries the ink which is printed onto the web 101 is frequently situated between the printing units 111 to 114 and the corresponding cooling rolls. The web 101 is guided over cooling rolls after a printing and optionally drying step. To this end, a cooling roll 121 is arranged in the web section between the first printing unit 111 and the second printing unit 112, a cooling roll 122 is arranged in the section between the second printing unit 112 and the third printing unit 113, a cooling roll 123 is arranged in the section between the third printing unit 113 and the fourth printing unit 114, and a fourth cooling roll 124 is arranged in the section between the fourth printing unit 114 and the outfeed unit 115. According to the embodiment shown of the printing press, all the cooling rolls 121 to 124 are independently driven and are equipped with dedicated drives 121″′ to 124″′ for this purpose. In other machine types or print applications, the driven rolls 121 to 124 can, for example, also have temperature-increasing functions (heating rolls) or other functions.

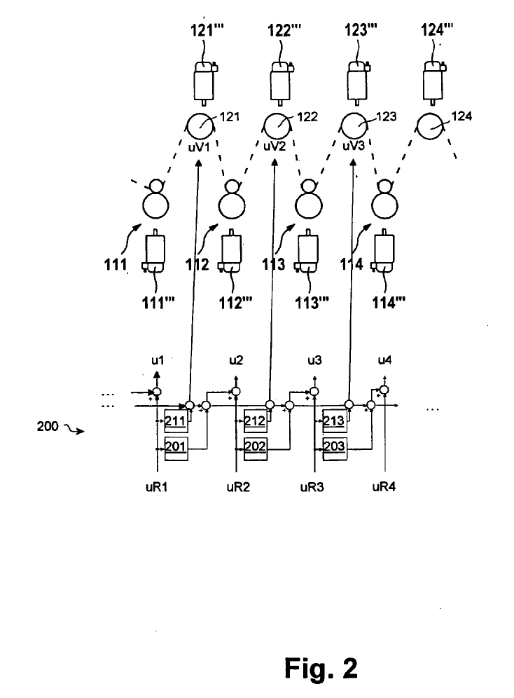

Using FIG. 2, it will be described how, in the printing press shown, the independently driven cooling rolls are incorporated into a web tension and/or register control operation. It goes without saying that the described manner likewise applies to other independently driven rolls. In FIG. 2, a downstream control strategy with decoupling is described using the example of the printing press according to FIG. 1, only the elements which are essential for the example being depicted in FIG. 2, however. Downstream means that adjustments are carried out in the web running direction. If an actuator i (for example, an impression cylinder) is to be adjusted, the actuator i itself is adjusted. Upstream means that an adjustment is carried out counter to the web running direction. If the actuator i is to be adjusted, all actuators 1, 2, . . . , i-1 lying in front of it (usually including the infeed means) are adjusted, but the actuator i is left unchanged. It is known to also adjust all following actuators i+1, i+2, . . . , n in both strategies for decoupling reasons.

In a controller (not shown), actuating variables (controller output variables) uR1, uR2, uR3 and uR4 are determined for the drives 111″′ to 114″′ of the printing units 111 to 114. In order to control the web tension, the actuating variables can be, for example, rotational speeds, precision calibration and the like. In the case of the control of the register, the actuating variable is, for example, an angular offset or the like. The actuating variables are processed by a decoupling network 200 and are provided to the drives as changed actuating variables u1, u2, u3 and u4. To this end, the decoupling network 200 comprises control elements 201-203 and 211-213. Furthermore, the decoupling network 200 provides actuating variables uV1, uV2, uV3 for the drives of the cooling rolls.

The control elements 201-203 serve for downstream decoupling of the printing units from an actuating movement. The control elements 211-213 serve for downstream decoupling of the driven cooling rolls and bring about pilot control as a function of an actuating variable. The actual embodiment of the pilot control is generally dependent on the control strategy (precursor color or reference color) and the adjusting direction (downstream or upstream). The control elements 211-213 represent corresponding dynamic decoupling strategies. In the case of downstream precursor color control, pilot control can take place, for example, via a combination of a DT1 element and a dead time. The time constants of the control elements are dependent on the material web length, here firstly from the printing unit to the cooling roll and secondly from the cooling roll to the printing unit, and on the material web speed. For example, in the case of an adjustment of the drive 111″′ on the basis of an actuating variable uR1, the latter would be guided unchanged to the drive and would be additionally pilot-controlled via the control element 211 which takes the web length between the roll 111′ and the roll 121 into consideration and the control element 201 which takes the web length between the roll 121 and the roll 112′ into consideration to the following actuators, the pilot control variable and the actuating variables uV1, u2, uV2, u3, uV3, u4 being integrated.

In the present example, the cooling rolls are not controlled, and therefore no actuating variables (controller output variables) are provided for the cooling rolls. As an option, the cooling rolls could also be controlled in addition to the pilot control. In this case, the associated actuating variable for a cooling roll would expediently be decoupled dynamically, just like the actuating variables for the impression cylinders. The decoupling expediently takes place by means of dynamic timing elements. The latter can be, for example, PT1, PT2, PTn, DT1, DT2, DTn elements, dead times, etc. Furthermore, nonlinear pilot control operations which have similar profiles to the dynamic timing elements are also permissible.

1. A method for controlling a control variable for a processing machine, comprising:
driving a plurality of rolls of the processing machine to transport and/or to process a material web, at least one driven roll of the plurality of rolls is not a constituent part of a clamping point;
adjusting the at least one driven roll, which is not a constituent part of a clamping point, with a first actuator; and
pilot-controlling the first actuator as a function of an actuating value with respect to a second actuator.

2. The method as claimed in claim 1, wherein the at least one driven roll, which is not a constituent part of a clamping point, is configured as a cooling/heating roll or a guide roll.

3. The method as claimed in claim 1, wherein a processing, transport, cooling, heating and/or guide roll or their/its drive serves as the second actuator.

4. The method as claimed in claim 1, wherein a compensator serves as the second actuator.

5. The method as claimed in claim 1, wherein the control variable is a processing register and/or a web tension.

6. The method as claimed in claim 1, wherein the pilot control takes place in a model-based and/or adaptive manner.

7. The method as claimed in claim 1, wherein a sliding slippage and/or expansion slippage of the at least one driven roll, which is not a constituent part of a clamping point, is taken into consideration in the pilot control.

8. The method as claimed in claim 1, wherein the pilot control takes place in a steady-state and/or dynamic manner for different speed states.

9. The method as claimed in claim 1, further comprising:
pilot-controlling the at least one driven roll being controlled and at least one third actuator as a function of the actuating value for the first actuator.

10. The method as claimed in claim 1, wherein a computing unit is configured to carry out the method.
